(19) United States
(12) Patent Application Publication
(10) Pub. No.: US 2026/0289042 A1
(43) Pub. Date: Sep. 24, 2026

(54) METHOD FOR DETERMINING TOTAL IONIZING DOSE WITH SPHERICAL MODEL

(71) Applicant: Raytheon Company, Arlington, VA (US)

(72) Inventor: Steven J. Manson, Tucson, AZ (US)

(21) Appl. No.: 19/083,102

(22) Filed: Mar. 18, 2025

(51) Int. Cl. G06F 30/25; G06F 30/15; G06T 15/06

(52) U.S. Cl. CPC G06F 30/25; G06F 30/15; G06T 15/06

(57) ABSTRACT

A system for generating a radiation transport model includes a memory and a processor configured to generate a histogram of areal density measurements that are measured by directional sampling of a CAD model. The histogram bins are mapped to a spherical model comprising longitudinal wedges, where respective wedges have an areal density value derived from the histogram bins, and an azimuthal angular extent given by the respective bins of the histogram. The spherical model can be used to determine a total ionization dose for an electronic component positioned at the location of the CAD model. The total ionization dose can be used to adjust shielding material in the CAD model.

### BACKGROUND

Radiation transport modeling simulates interactions between radiation and matter (e.g., various materials surrounding an electronic component) and can provide estimates of a total ionization dose (TID) experienced by an electronic component. The various materials may be provided to the simulation through a computer-aided design model (CAD) of a real-world device.

Contexts where radiation exposure is a concern include space exploration, nuclear power generation, and radiation therapy in medicine. When designing devices (e.g., spacecraft) to deploy in such contexts, a CAD model may undergo several iterations.

### SUMMARY

The present solution provides a system and method for generating a radiation transport model to estimate the total ionizing dose (TID) experienced by electronic components in environments with radiation exposure. The system comprises a memory and a processor configured to perform several operations. Initially, the system generates a histogram of areal density measurements obtained through directional sampling of a computer-aided design (CAD) model. This sampling involves raytracing from a central point in the CAD model, which corresponds to the position of an electronic component, and propagates outward to a bounding sphere. The rays are uniformly distributed in a solid angle, ensuring comprehensive coverage of potential radiation exposure scenarios.

The processor maps the respective bins of the histogram to angular extents proportional to the number of measurements in each bin. This mapping is used to generate a spherical model comprising a plurality of longitudinal wedges. Each wedge has an areal density value derived from the histogram bins and an azimuthal angular extent based on the mapped angular extents. The spherical model serves as the radiation transport model for determining the TID for a representative element, such as a silicon witness, positioned at the center of the spherical model.

The solution includes the capability to simulate various types of radiation, including beta particles and photons, with specified energy distributions. The radiation transport simulation applies effects of physics interactions to simulate the passage of particles or radiation through the spherical model. This approach allows for a more accurate estimation of TID compared to traditional one-dimensional models, which tend to be overly conservative.

One benefit of this solution is the ability to provide a more representative and efficient estimation of TID during early-phase design evaluations. This is achieved by bridging the gap between overly conservative one-dimensional models and resource-intensive three-dimensional models. The system can also generate multiple spherical models for different electronic components within the CAD model, allowing for comprehensive TID assessments across various components.

Additionally, the solution enables adjustments to the shielding material in the CAD model based on the determined TID. This adjustment is based on criteria such as enabling the electronic component to survive exposure to the TID and minimizing the total mass of the spacecraft. The system's ability to store the TID in memory ensures that the calculated values are available for further analysis and design optimization. Overall, the solution provides a practical approach to estimating TID, facilitating informed decision-making in the design and development of systems exposed to radiation environments.

### BRIEF DESCRIPTION OF THE DRAWINGS

FIG. 1 illustrates a schematic diagram of a spacecraft with electronic components and shielding material for TID determination according to at least one example of the present disclosure.

FIG. 2 illustrates a CAD model with raytracing vectors for TID determination according to at least one example of the present disclosure.

FIG. 3 illustrates a CAD model with raytracing vectors that measure areal density according to at least one example of the present disclosure.

FIG. 4 illustrates a graph with a distribution of areal density measurements in a histogram according to at least one example of the present disclosure.

FIG. 5 illustrates a spherical model with longitudinal wedges used for TID determination according to at least one example of the present disclosure.

FIG. 6 illustrates a graph with another heuristic for distributing areal density measurements in a histogram according to at least one example of the present disclosure.

FIG. 7 illustrates a spherical model with longitudinal wedges from another heuristic for distributing areal density measurements in the histogram of FIG. 6 according to at least one example of the present disclosure.

FIG. 8 illustrates a graph with another alternative heuristic for distributing areal density measurements in a histogram according to at least one example of the present disclosure.

FIG. 9 illustrates a spherical model with longitudinal wedges from another alternative heuristic for distributing areal density measurements in the histogram of FIG. 8 according to at least one example of the present disclosure.

FIG. 10 illustrates a cross-sectional view of TID determination using the spherical model according to at least one example of the present disclosure.

FIG. 11 illustrates a flow chart of a method for generating a spherical model to determine TID for an electronic component in a CAD model according to at least one example of the present disclosure.

FIG. 12 illustrates an example of a block diagram of a machine upon which techniques discussed in any of FIG. 1-11 may perform in accordance with some examples.

### DETAILED DESCRIPTION

The use of radiation transport modeling can aid designers in selecting electronic components for space missions or nuclear environments. Radiation transport modeling can produce an estimate of a total ionizing dose (TID) that electronic components may experience during a mission. Including a radiation transport model in a spacecraft design can prevent electronic systems from experiencing considerable damage. Often, methods for estimating TID rely on one-dimensional (1D) models of the spacecraft or mechanical environment in which the electronic components will be deployed. The 1D models are straightforward to use but tend to be overly conservative by overestimating the TID, leading to unnecessary design constraints and increased costs due to the need for more robust and expensive components (e.g., additional shielding, radiation hard electronic components).

Another approach to estimate TID is to use fully three-dimensional (3D) radiation transport models. A 3D radiation transport model may provide a more accurate representation of the radiation environment by considering the detailed geometry and material properties of the system. However, 3D radiation transport models can be computationally intensive and time-consuming to develop, often requiring significant resources and expertise. Additionally, the complexity and resource demands of 3D models make them impractical for early-stage design processes, where CAD models are still evolving, and rapid design iterations are necessary.

The present disclosure addresses these challenges by providing a method for generating a simplified yet representative 3D model for TID estimation. This method leverages directional sampling and raytracing techniques within a computer-aided design (CAD) model to construct a spherical model with longitudinal wedges. Each wedge corresponds to a bin of areal density measurements, allowing for a more accurate and efficient estimation of TID. This approach bridges the gap between the overly conservative 1D models and the resource-intensive 3D models, offering a practical solution for early-phase design evaluations.

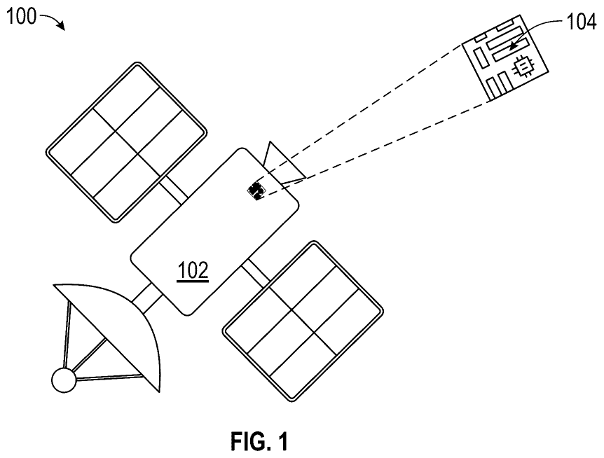

FIG. 1 illustrates a schematic diagram of a spacecraft 100 with electronic component 104 and shielding material 102 for TID determination according to at least one example of the present disclosure. The spacecraft 100 may be configured to operate in environments where radiation exposure is a concern, such as space missions, and may include various components that require protection from radiation.

The shielding material 102 may be included in the spacecraft 100 to provide radiation protection to the electronic component 104. The shielding material 102 can be composed of various materials, such as aluminum, copper, or other metals, and may be placed throughout the spacecraft 100 to minimize radiation exposure to sensitive areas of the spacecraft 100. The effectiveness of the shielding material 102 may be evaluated using the TID determination method described in the present disclosure.

The electronic component 104 may include components that operate the spacecraft 100, such as communication devices, sensors, and control systems. The electronic component 104 may include components that are part of a payload for which the spacecraft 100 is deployed. For example, the spacecraft 100 may be an imaging satellite and the electronic component 104 may be any of the electronic componentry (e.g., imaging sensor, camera electronics, signal processing electronics) used to acquiring imagery. The TID determination method disclosed can be used to select an appropriate version(s) (e.g., radiation hardened versions of memory, processors, etc.) of electronic component 104 that can withstand the radiation levels encountered during the mission.

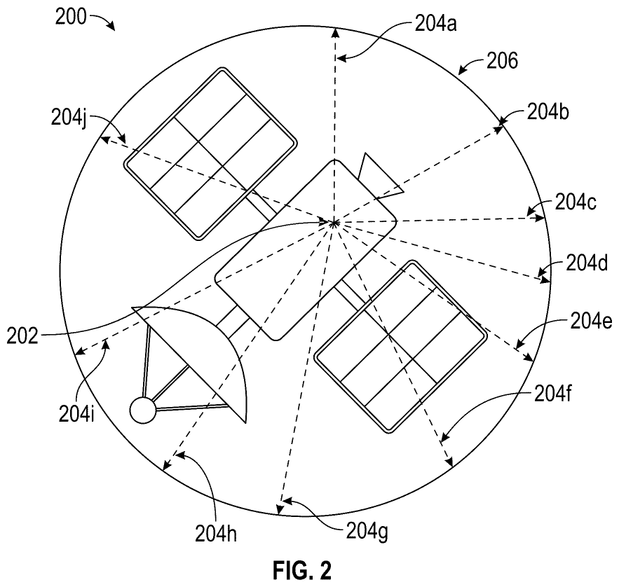

FIG. 2 illustrates a CAD model 200 with raytracing vectors for TID determination according to at least one example of the present disclosure. For example, the CAD model 200 may use a three-dimensional computer aided design model of the spacecraft 100, and a series of rays 204a-j may be introduced in a raytracing environment (e.g., a raytracing computation extension in the CAD software used to create the CAD model 200, or a stand-alone raytracing computation environment). The raytracing environment may use a central point 202 and a bounding surface 206, such that rays 204a-j originate at the central point 202 and terminate at the bounding surface 206.

The central point 202 may be located at the position of an electronic component (e.g., component 104) within the CAD model 200. The central point 202 acts as the reference from which rays are emitted in a solid angle. The selection of the central point 202 may be based on the specific electronic component being analyzed, ensuring that the TID estimation is relevant to the component's actual operational environment.

The rays 204a-j may be a series of vectors that originate from the central point 202 and extend outward to the bounding surface 206. Any suitable number of rays (e.g., 100, 10,000, 500,000, etc.) may be included in the rays 204 a-j. The rays may be equally distributed in 4π-solid angle. In an example, the rays may be preferentially distributed towards a particular direction, such as a side of the spacecraft that may be expected to experience a higher radiation environment (e.g., that is semi-permanently pointed towards a radiation source during the mission). The rays 204a-j may be configured to pass through surfaces and materials that the rays 204a-j encounter without scattering, reflection, diffraction, etc. The raytracing process may use the rays 204a-j to track the intersections of the rays 204a-j with surfaces of the CAD model, allowing for the determination of material properties such as type, density, and thickness.

The bounding surface 206 may be a spherical shell that encapsulates the CAD model and serves as a termination point for the rays 204a-j. The bounding surface 206 may define the outer boundary of the raytracing environment. The bounding surface 206 may have any suitable size and position, e.g., based on the dimensions of the CAD model. In an example, the bounding surface 206 may have any suitable geometry other than a spherical shell.

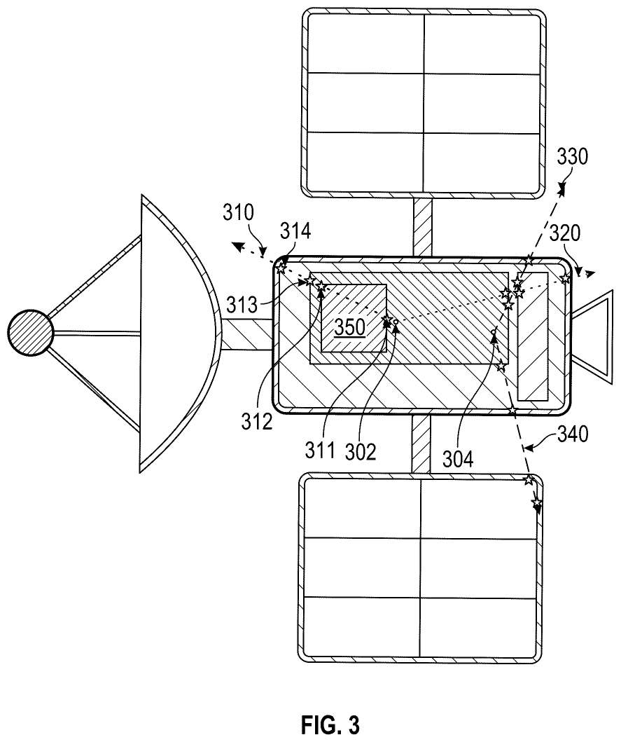

FIG. 3 illustrates a CAD model in raytracing environment 300 with raytracing vectors that measure areal density according to at least one example of the present disclosure. As shown in FIG. 3, raytracing vectors 310 and 320 may originate at a first central point 302 and raytracing vectors 330 and 340 may originate at a second central point 304. As discussed in FIG. 2, the first central point 302 and the second central point 304 may correspond to location(s) in the CAD model of the spacecraft for housing various electronic components.

In an example, raytracing vectors 310 and 320 may intersect materials of varying densities within the CAD model (e.g., spacecraft, shielding material, payload material, fuel, etc.). As shown in FIG. 3, raytracing vector 310 may encounter various surfaces as indicated at point 311, point 312, point 313, and point 314. In an example, the raytracing environment 300 may be configured to register material properties along raytracing vector 310. In an example, the raytracing environment 300 may record a coordinate (e.g., three-dimensional cartesian coordinate, three-dimensional spherical coordinate, etc.), material type, material density, etc., for the first central point 302 and points 311-314. The raytracing environment 300 may compute a path length between the first central point 302 and point 311. In an example, point 311 may be a location where raytracing vector 310 enters surface 350, and point 312 may be a location where raytracing vector 310 exits surface 350. In an example, the raytracing environment 300 may compute a path length of raytracing vector through surface 350 using point 311 and point 312. In an example, the raytracing environment 300 may compute path lengths through any or all surfaces encountered by raytracing vector 310. In an example, the raytracing environment 300 may use any suitable length determination (e.g., Euclidian distance) as a path length.

In an example, the raytracing environment 300 may use a path length to determine an areal density value. The areal density may be a combination of a material volume density (e.g., ρ, having S.I. units of kg/m³) and the path length (e.g., having S.I. units of m) of a given raytracing vector through the material (e.g., columnar density, having S.I. units of kg/m²). In an example, the raytracing environment 300 may determine several areal densities along a given raytracing vector.

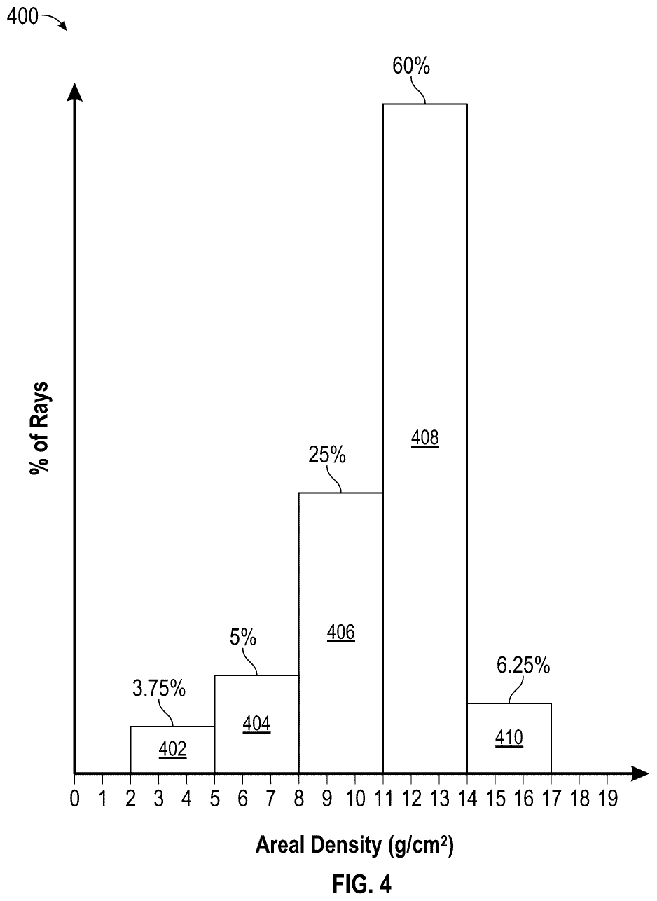

FIG. 4 illustrates a graph 400 with a distribution of areal density measurements in a histogram according to at least one example of the present disclosure. In an example, the graph 400 includes five groupings of areal density, shown as bars 402-410. In the example of FIG. 4, the bars 402-410 have equal widths on the areal density axis. That is, each bar 402-410 spans three units of areal density.

In the example of FIG. 4, bar 402 shows that 3.75% of areal density measurements (e.g., resulting from raytracing a given spacecraft CAD model, as described in FIGS. 2 and 3) are greater than 2 g/cm² and less than 5 g/cm². Continuing, bar 404 shows that 5% of areal density measurements are greater than 5 g/cm² and less than 8 g/cm², bar 406 shows that 25% of areal density measurements are greater than 8 g/cm² and less than 11 g/cm², bar 408 shows that 60% of areal density measurements are greater than 11 g/cm² and less than 14 g/cm², and bar 410 shows that 6.25% of areal density measurements are greater than 14 g/cm² and less than 17 g/cm².

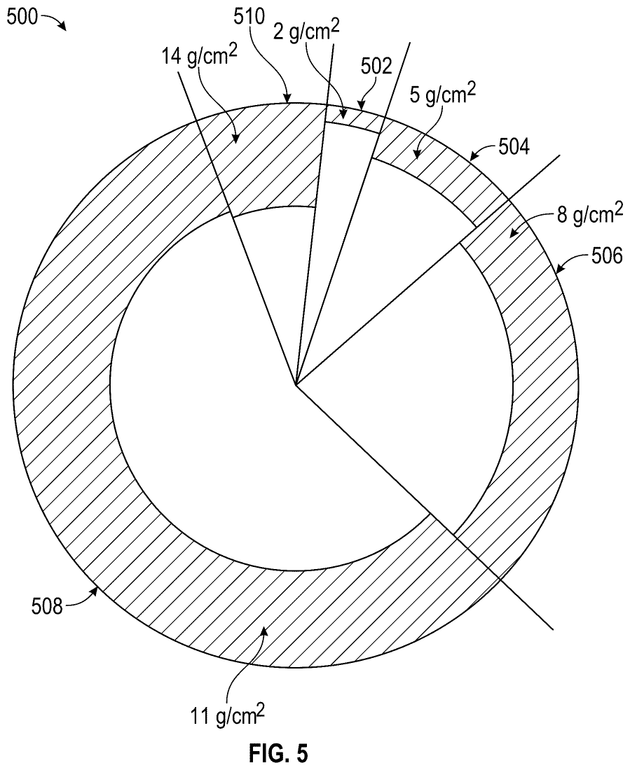

FIG. 5 illustrates a spherical model 500 with longitudinal wedges used for TID determination according to at least one example of the present disclosure. In the view of FIG. 5, the orientation of the spherical model 500 can be understood to be in the equatorial plane, that is, viewing the sphere top-down from one of the poles.

The spherical model 500 may be constructed using the areal density data corresponding to the histogram of graph 400. That is, wedges 502-510 may correspond to a representation of the groupings shown by bars 402-410 (respectively). In detail, wedge 502 may be assigned an azimuthal extent that corresponds to the frequency value of bar 402 (3.75% of 2π radians is approximately 0.23 radians or 13.5°), and an areal density value that corresponds to the lower bound of the histogram range of bar 402 (e.g., 2 g/cm²). Wedge 504 may be assigned an azimuthal extent that corresponds to the frequency value of bar 404 (5% of 2π radians is approximately 0.31 radians or 18°), and an areal density value that corresponds to the lower bound of the histogram range of bar 404 (e.g., 5 g/cm²). Wedge 506 may be assigned an azimuthal extent that corresponds to the frequency value of bar 406 (25% of 2π radians is approximately 1.57 radians or 90°), and an areal density value that corresponds to the lower bound of the histogram range of bar 406 (e.g., 8 g/cm²). Wedge 508 may be assigned an azimuthal extent that corresponds to the frequency value of bar 408 (60% of 2π radians is approximately 3.76 radians or 216°), and an areal density value that corresponds to the lower bound of the histogram range of bar 408 (e.g., 11 g/cm²). Wedge 510 may be assigned an azimuthal extent that corresponds to the frequency value of bar 410 (6.25% of 2π radians is approximately 0.39 radians or 22.5°), and an areal density value that corresponds to the lower bound of the histogram range of bar 410 (e.g., 14 g/cm²).

In an example, selecting the lower bound of the histogram range for each of the bars 402-410 in the corresponding histogram of graph 400 to be the areal density value of the corresponding wedge in the spherical model 500 may provide a conservative estimate of TID. Other values in the histogram range may be selected for a wedge's areal density, such as an average areal density value or the upper bound areal density value of the corresponding histogram range.

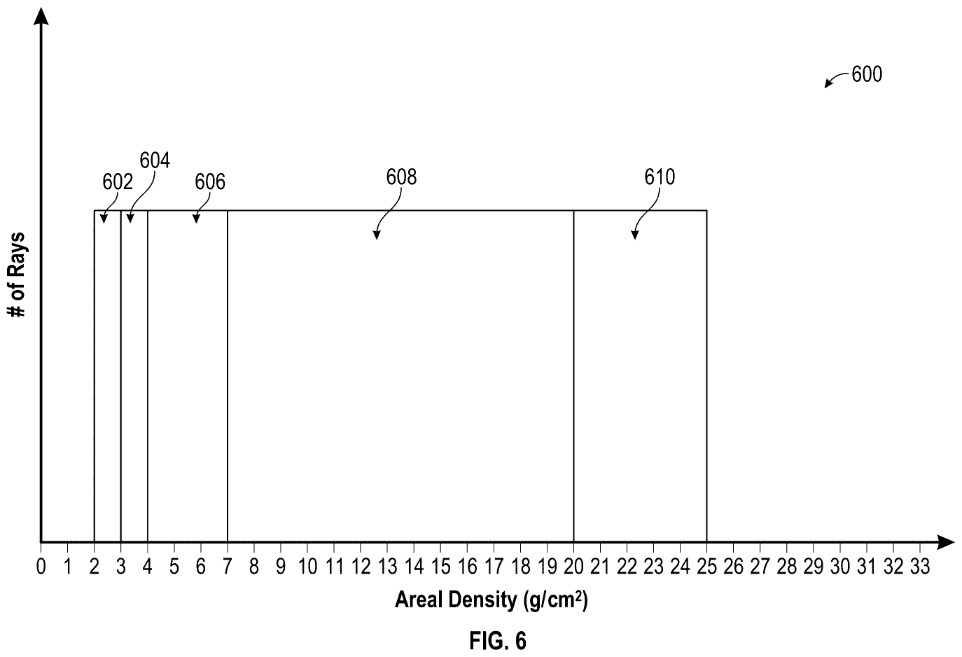

FIG. 6 illustrates a graph 600 with another heuristic for distributing areal density measurements in a histogram according to at least one example of the present disclosure. In an example, the graph 600 includes five groupings of areal density, shown as bars 602-610. In the example of FIG. 6, the data represented by bars 602-610 is grouped so that the bars 602-610 have equal heights (e.g., equal frequencies in the histogram). This has the result of varying the widths for each bar on the areal density axis.

In the example of FIG. 6, bar 602 shows that 20% of areal density measurements (e.g., resulting from raytracing a given spacecraft CAD model, as described in FIGS. 2 and 3) are greater than 2 g/cm² and less than 3 g/cm². Continuing, bar 604 shows that 20% of areal density measurements are greater than 3 g/cm² and less than 4 g/cm², bar 606 shows that 20% of areal density measurements are greater than 4 g/cm² and less than 7 g/cm², bar 608 shows that 20% of areal density measurements are greater than 7 g/cm² and less than 120 g/cm², and bar 610 shows that 20% of areal density measurements are greater than 20 g/cm² and less than 25 g/cm².

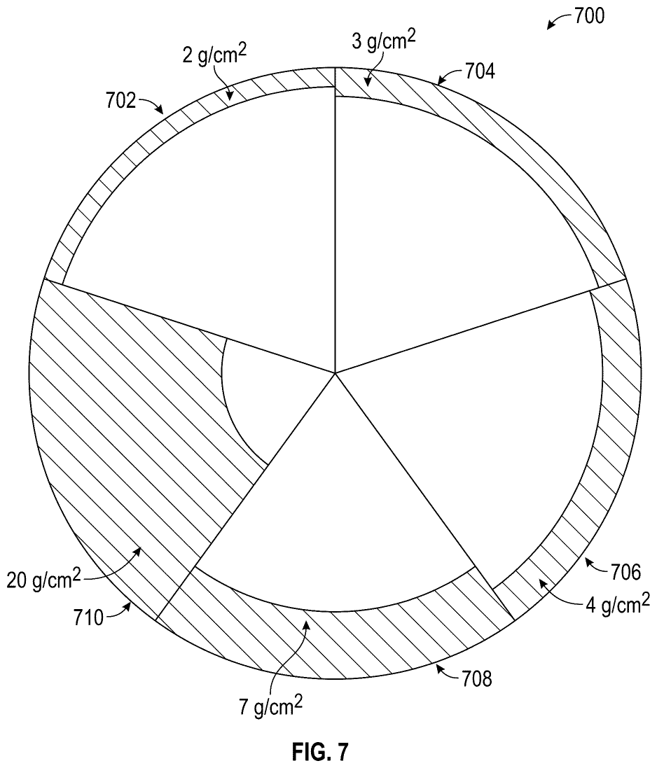

FIG. 7 illustrates a spherical model 700 with longitudinal wedges from the alternative heuristic for distributing areal density measurements in the histogram of FIG. 6 according to at least one example of the present disclosure. In the view of FIG. 7, the orientation of the spherical model 700 can be understood to be in the equatorial plane, that is, viewing the sphere top-down from one of the poles.

The spherical model 700 may be constructed using the areal density data corresponding to the histogram of graph 600. That is, wedges 702-710 may correspond to a representation of the groupings shown by bars 602-610 (respectively).

In detail, wedge 702 may be assigned an azimuthal extent that corresponds to the frequency value of bar 602 (20% of 2π radians is approximately 1.25 radians or 72°), and an areal density value that corresponds to the lower bound of the histogram range of bar 402 (e.g., 2 g/cm²). Wedge 704 may be assigned an azimuthal extent that corresponds to the frequency value of bar 604 (e.g., 72°), and an areal density value that corresponds to the lower bound of the histogram range of bar 604 (e.g., 3 g/cm²). Wedge 706 may be assigned an azimuthal extent that corresponds to the frequency value of bar 606 (e.g., 72°), and an areal density value that corresponds to the lower bound of the histogram range of bar 606 (e.g., 4 g/cm²). Wedge 708 may be assigned an azimuthal extent that corresponds to the frequency value of bar 608 (e.g., 72°), and an areal density value that corresponds to the lower bound of the histogram range of bar 608 (e.g., 7 g/cm²). Wedge 510 may be assigned an azimuthal extent that corresponds to the frequency value of bar 610 (e.g., 72°), and an areal density value that corresponds to the lower bound of the histogram range of bar 610 (e.g., 20 g/cm²).

In an example, selecting the lower bound of the histogram range for each of the bars 602-610 in the corresponding histogram of graph 400 to be the areal density value of the corresponding wedge in the spherical model 700 may provide a conservative estimate of TID. Other values in the histogram range may be selected for a wedge's areal density, such as an average areal density value or the upper bound areal density value of the corresponding histogram range.

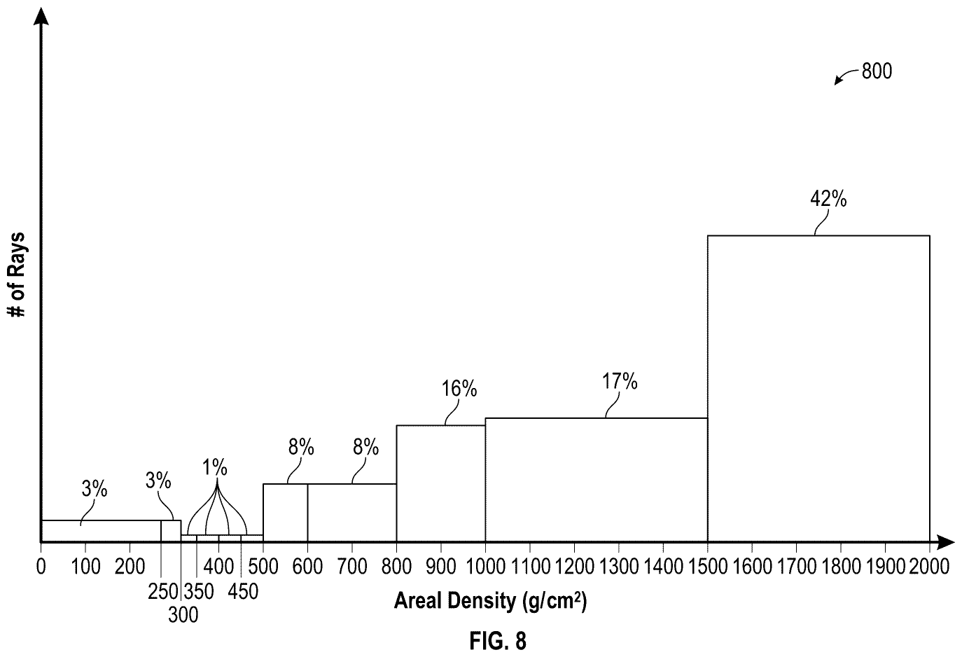

FIG. 8 illustrates a graph 800 with another alternative heuristic for distributing areal density measurements in a histogram according to at least one example of the present disclosure. In an example, the graph 800 includes eleven groupings of areal density, with varying spans of areal density and with varying frequencies (along the # of rays axis). In the example of FIG. 8, the groupings can be a mixture of equal height (frequency) and of equal width (e.g., along the areal density axis). Grouping the data to result in the graph 800 may reflect additional considerations to given to the CAD model (e.g., CAD model 200), such as the materials used for shielding, and to the expected radiation environment of the CAD model 200 when deployed as a spacecraft.

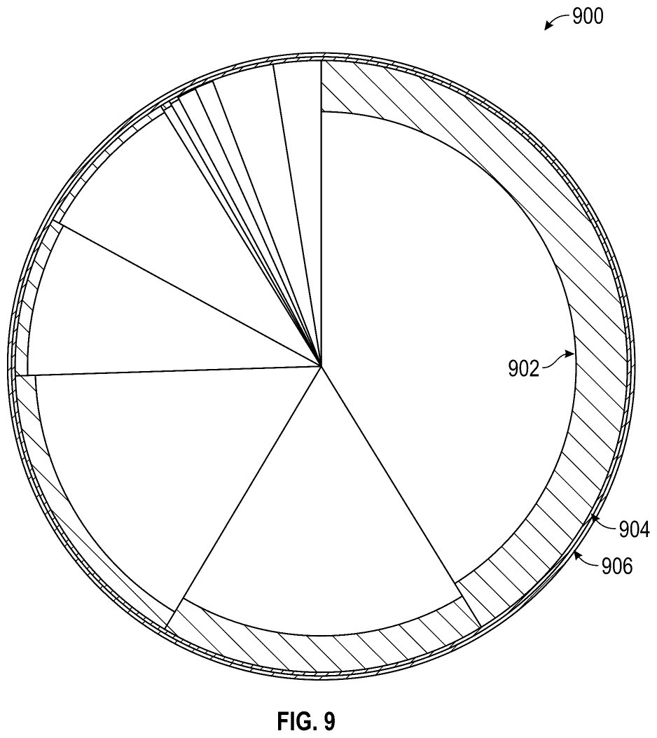

FIG. 9 illustrates a spherical model with longitudinal wedges from another alternative heuristic for distributing areal density measurements in the histogram of FIG. 8 according to at least one example of the present disclosure. In the view of FIG. 7, the orientation of the spherical model 700 can be understood to be in the equatorial plane, that is, viewing the sphere top-down from one of the poles.

The spherical model 900 includes thirteen longitudinal wedges where the azimuthal angular extent for a given wedge may correspond to the frequency of occurrence in the histogram of graph 800. In an example, the areal density values used in respective longitudinal wedges may be selected from a lower bound, upper bound, or other value in the corresponding histogram region of graph 800. Additionally, the spherical model 900 may include layers of material such as material 902, material 904, and material 906. In the spherical model 900, the areal density for material 902 can be seen to vary across different longitudinal wedges, with two longitudinal wedges in the spherical model 900 being constructed without the material 902 as only eleven groupings were made in histogram of graph 800. This corresponds to different path lengths measured when raytracing in the CAD model. The addition of layers of material 904 can follow a similar histogram grouping as described for FIG. 4 and FIG. 6. In an example, the layers of material 904 and 906 can be given the same azimuthal angular extents as those calculated for the layers of material 902. In an example, the layers of material 904 and 906 can be given a different azimuthal angular extent as those calculated for the layers of material 902.

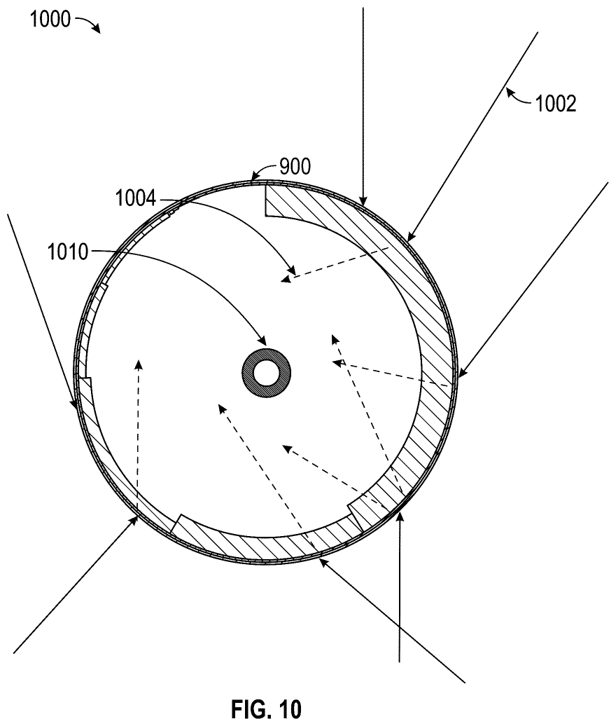

FIG. 10 illustrates a cross-sectional view of TID determination using the spherical model according to at least one example of the present disclosure. FIG. 10 includes a TID model 1000 that uses the spherical model 900 with incoming particle rays 1002, and can determine secondary particle scatter 1004 and a TID for a silicon witness 1010 positioned at the center of the spherical model 900.

The TID model 1000 model may be configured to simulate the radiation environment that the electronic components will encounter during a mission. The TID model 1000 uses the spherical model 900 as the radiation transport model to determine the TID for a representative element (silicon witness 1010) positioned at the center of the spherical model. The TID model 1000 is configured for use in one or more radiation transport simulations that utilize a three-dimensional representation of materials as an input, and further apply effects of physics interactions to simulate the passage of particles or radiation through the spherical model. The radiation transport simulation includes beta particles with an energy distribution in a range of 0.01 mega electron volt (MeV) to 11 MeV, and includes photons with an energy distribution in a range of 0.1 kilo electron volt (keV) to 100 MeV. Examples of computer instructions that can perform radiation transport modeling include Monte Carlo N-Particle code (e.g., MCNP, distributed by Los Alamos National Laboratory), Monte Carlo photon-electron transport code (e.g., Integrated Tiger Series or ITS, distributed by Sandia National Laboratories), Monte Carlo transport program (e.g., TART, distributed by Lawrence Livermore National Laboratory), and Geant4 distributed by CERN, among other examples.

The incoming particle ray 1002 represents the radiation particles used in the TID model 1000. These rays are simulated to interact with the various material layers and longitudinal wedges within the spherical model 900. The simulation of these rays allows for the calculation of the TID by tracking the interactions of the rays with the materials, including absorption, scattering, and energy deposition. This information is used to adjust the shielding material in the CAD model based on the TID determined for a selected central point, wherein the shielding material adjustment is based on one or more criteria including enabling a respective electronic component at the selected central point to survive exposure to the TID and minimizing a total amount of mass in the spacecraft.

The secondary particle scatter 1004 is a phenomenon that occurs when the incoming particle ray 1002 interacts with the materials within the TID model 1000. This interaction can result in the generation of secondary particles, which can further contribute to the ionization dose received by the representative element (silicon witness 1010).

The silicon witness 1010 is a representative element positioned at the center of the TID model 1000. This element serves as a proxy for the electronic components that are being evaluated for radiation exposure. The silicon witness 1010 is used to measure the TID by simulating the radiation interactions within the spherical model.

In an example, a TID output from the TID model 1000 may be an estimate for the electronic component in the location of the spacecraft. Such an estimate may be used to inform additional shielding material, component selection (e.g., radiation hardened electronic components), etc., for additional iterations of the CAD model of the spacecraft.

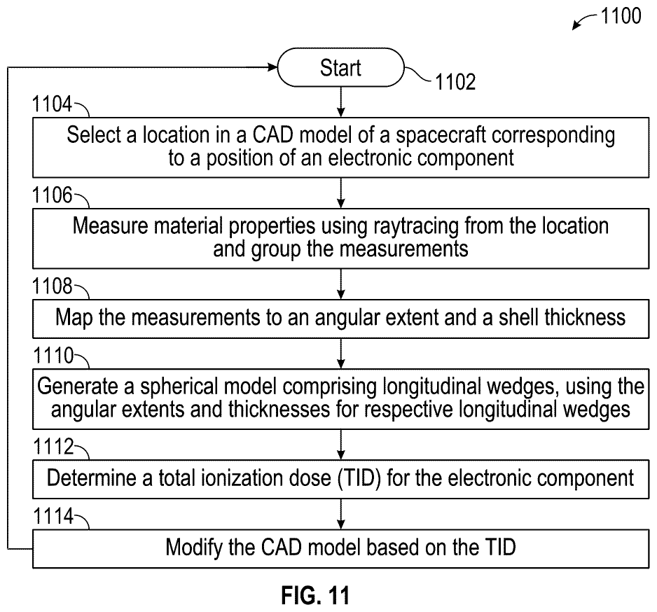

FIG. 11 illustrates a flow chart of a method 1100 for generating a spherical model to determine TID for an electronic component in a CAD model according to at least one example of the present disclosure. This method leverages directional sampling and raytracing techniques to construct a simplified yet representative 3D model for TID estimation. While the various operations in this flowchart are presented and described sequentially, one of ordinary skill will appreciate that some or all of the operations may be executed in a different order, be combined or omitted, or be executed in parallel.

At operation 1102, the method 1100 may start by identifying a CAD model that comprises a spacecraft having electronic components.

At operation 1104, the method 1100 may continue by selecting a location in the CAD model that comprises the spacecraft, the location corresponding to a position of an electronic component.

At operation 1106, the method 1100 may continue by measuring material properties of surfaces identified using raytracing, the raytracing originating from the location selected at operation 1102. The operation 1106 may include grouping the material properties, such as in a histogram, as discussed in FIGS. 4, 6, and 8 above.

At operation 1108, the method 1100 may continue by mapping the measurements of material properties to an angular extent and a shell thickness. In an example, the angular extent and the shell thickness mapping may be determined using the grouping (e.g., histogram) from operation 1106.

At operation 1110, the method 1100 may continue by generating a spherical model comprising longitudinal wedges. In an example, the longitudinal wedges may have respective angular extents and shell thicknesses corresponding to the mapping in operation 1108.

At operation 1112, the method 1100 may continue by determining a total ionization does (TID) for the electronic component. In an example, the TID may be determined by subjecting the spherical model from operation 1110 to a radiation transport model, with a silicon witness placed at the center of the spherical model.

At operation 1114, the method 1100 may continue by modifying the CAD model based on the TID determined in operation 1112. In an example, the CAD model may be modified by selecting a version (e.g., radiation hardened version) of the electronic component based on a TID value. In an example, the CAD model may be modified by adding additional material (e.g., for shielding) to reduce the TID value experienced by the electronic component.

The method 1100 may iterate after operation 1114. In an example, the method 1100 may iterate based upon the modified CAD model (e.g., with additional shielding material). In an example, the method 1100 may iterate to select a new location for another electronic component. In an example, the method 1100 may iterate across all locations of electronic components and may modify the CAD model (e.g., at operation 1114) based upon multiple TID determined at respective locations for multiple electronic components.

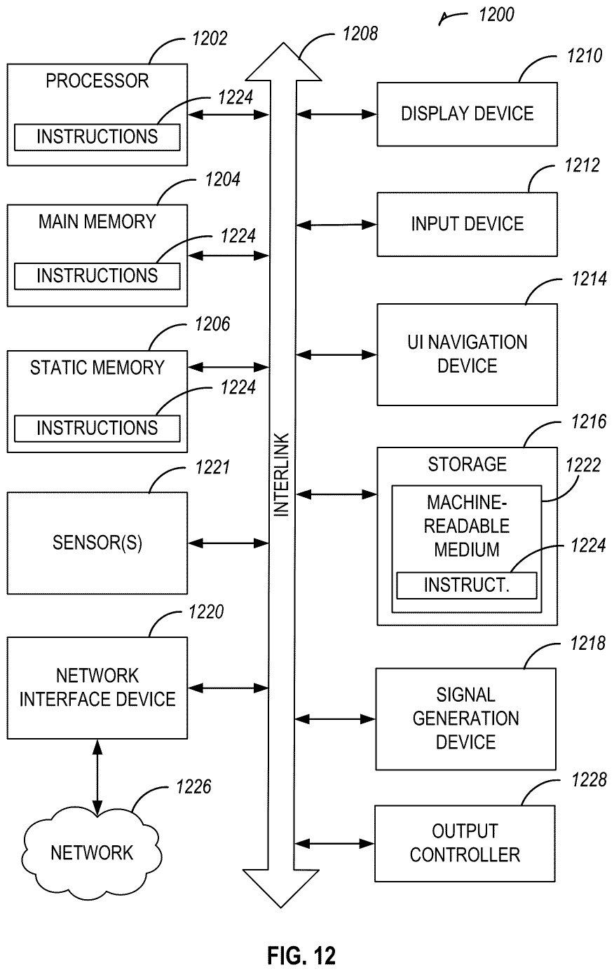

FIG. 12 illustrates generally an example of a block diagram of a machine 1200 upon which any one or more of the techniques (e.g., methodologies) discussed herein may perform in accordance with some examples. In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environment. The machine 1200 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution's units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 1200 may include a hardware processor 1202 (e.g., a central processing unit (CPU), a graphics processing unit (GPU), a hardware processor core, or any combination thereof), a main memory 1204 and a static memory 1206, some or all of which may communicate with each other via an interlink (e.g., bus) 1208. The machine 1200 may further include a display unit 1210, an alphanumeric input device 1212 (e.g., a keyboard), and a user interface (UI) navigation device 1214 (e.g., a mouse). In an example, the display unit 1210, alphanumeric input device 1212 and UI navigation device 1214 may be a touch screen display. The machine 1200 may additionally include a storage device (e.g., drive unit) 1216, a signal generation device 1218 (e.g., a speaker), a network interface device 1220, and one or more sensors 1221, such as a global positioning system (GPS) sensor, compass, accelerometer, or other sensor. The machine 1200 may include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1216 may include a machine readable medium 1222 that is non-transitory on which is stored one or more sets of data structures or instructions 1224 (e.g., software) embodying or utilized by any one or more of the techniques or functions described herein. The instructions 1224 may also reside, completely or at least partially, within the main memory 1204, within static memory 1206, or within the hardware processor 1202 during execution thereof by the machine 1200. In an example, one or any combination of the hardware processor 1202, the main memory 1204, the static memory 1206, or the storage device 1216 may constitute machine readable media.

While the machine readable medium 1222 is illustrated as a single medium, the term “machine readable medium” may include a single medium or multiple media (e.g., a centralized or distributed database, or associated caches and servers) configured to store the one or more instructions 1224.

The term “machine readable medium” may include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1224 may further be transmitted or received over a communications network 1226 using a transmission medium via the network interface device 1220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1220 may include one or more physical jacks (e.g., Ethernet, coaxial, or phone jacks) or one or more antennas to connect to the communications network 1226. In an example, the network interface device 1220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1200, and includes digital or analog communications signals or other intangible medium to facilitate communication of such software.

### ASPECTS

Aspect 1 can include subject matter such as a system for generating a radiation transport model, the system comprising: a memory; and a processor configured to: generate a histogram of areal density measurements that are measured by directional sampling of a computer-aided design (CAD) model; map respective bins of the histogram to respective angular extents that are proportional to a number of measurements in the respective bins; generate a spherical model comprising a plurality of longitudinal wedges, each longitudinal wedge having: an areal density value derived from respective bins of the histogram; and an azimuthal angular extent given by the respective bins of the histogram mapped to the respective angular extents; determine a total ionization dose (TID) using the spherical model as the radiation transport model, the TID determined for a representative element positioned at a center of the spherical model; wherein the memory is configured to store the TID.

Aspect 2 can include, or can optionally be combined with the subject matter of Aspect 1, to optionally include including the directional sampling further comprising raytracing that originates from a central point in the CAD model and propagates outward to a bounding sphere, the directional sampling uniformly distributed in a solid angle.

Aspect 3 can include, or can optionally be combined with the subject matter of one or any combination of Aspects 1 or 2 to optionally include the raytracing comprising a plurality of vectors, wherein respective vectors in the plurality of vectors encounter one or more surfaces of the CAD model.

Aspect 4 can include, or can optionally be combined with the subject matter of one or any combination of Aspects 1 to 3 to optionally include when a vector in the plurality of vectors encounters one or more surfaces of the CAD model, the directional sampling registers at least one or more of: a material type of a solid bounded by a subset of the one or more surfaces; a material property of the solid; a first intersection of the vector with a first surface in the one or more surfaces representing an entry location of the vector to the solid; a second intersection of the vector with a second surface in the one or more surfaces representing an exit location of the vector from the solid; a path length of the vector through the solid; or any combination thereof.

Aspect 5 can include, or can optionally be combined with the subject matter of one or any combination of Aspects 1 to 4 to optionally include the central point is a location within the CAD model corresponding to a position of an electronic component.

Aspect 6 can include, or can optionally be combined with the subject matter of one or any combination of Aspects 1 to 5 to optionally include the processor is configured to generate multiple spherical models, wherein respective spherical models use respective central points in the CAD model for the directional sampling such that a respective TID is determined for multiple electronic components in the CAD model.

Aspect 7 can include, or can optionally be combined with the subject matter of one or any combination of Aspects 1 to 6 to optionally include the CAD model comprises a model of a spacecraft, the spacecraft comprising shielding material and electronic componentry.

Aspect 8 can include, or can optionally be combined with the subject matter of one or any combination of Aspects 1 to 7 to optionally include the shielding material comprises at least one of: aluminum; copper; plastics; titanium; steel; heavy metal; structural componentry of the spacecraft; or any combination thereof.

Aspect 9 can include, or can optionally be combined with the subject matter of one or any combination of Aspects 1 to 8 to optionally include the shielding material is adjusted in the CAD model based on a TID determined for a selected central point, wherein the shielding material adjustment is based on one or more criteria including: enabling a respective electronic component at the selected central point to survive exposure to the TID; and minimizing a total amount of mass in the spacecraft.

Aspect 10 can include, or can optionally be combined with the subject matter of one or any combination of Aspects 1 to 9 to optionally include at least one TID is used in selecting an electronic component to be operated at the respective central point, wherein the electronic component is selected such that the electronic component can operate following exposure to the determined TID.

Aspect 11 can include, or can optionally be combined with the subject matter of one or any combination of Aspects 1 to 10 to optionally include the representative element is a silicon witness.

Aspect 12 can include, or can optionally be combined with the subject matter of one or any combination of Aspects 1 to 11 to optionally include the areal density value for at least one longitudinal wedge in the spherical model comprises at least two material density values, wherein respective material density values have a corresponding thickness in the longitudinal wedge.

Aspect 13 can include, or can optionally be combined with the subject matter of one or any combination of Aspects 1 to 12, to optionally include the spherical model is configured to be used in one or more radiation transport simulations that use a three-dimensional representation of materials as an input, and further that apply effects of physics interactions to simulate passage of particles or radiation through the spherical model.

Aspect 14 can include, or can optionally be combined with the subject matter of one or any combination of Aspects 1 to 13 to optionally include wherein the radiation transport simulation includes beta particles having an energy distribution in a range of 0.01 mega electron volt (MeV) to 11 MeV, further wherein the radiation transport simulation includes photons having an energy distribution in a range of 0.1 kilo electron volt (keV) to 100 MeV.

Aspect 15 can include subject matter such as a non-transitory computer-readable storage device that stores instructions for execution by one or more processors configured to generate a radiation transport model, wherein the processors are configured to: generate a histogram of areal density measurements that are measured by directional sampling of a computer-aided design (CAD) model; map respective bins of the histogram to respective angular extents that are proportional to a number of measurements in the respective bins; generate a spherical model comprising a plurality of longitudinal wedges, each longitudinal wedge having: an areal density value derived from respective bins of the histogram; and an azimuthal angular extent given by the respective bins of the histogram mapped to the respective angular extents; and determine a total ionization dose (TID) using the spherical model as the radiation transport model, the TID determined for a silicon witness positioned at a center of the spherical model.

Aspect 16 can include, or can optionally be combined with the subject matter of one or any combination of Aspect 15 to optionally include the directional sampling comprises raytracing that originates from a central point in the CAD model corresponding to a position of an electronic component, wherein the raytracing propagates outward to a bounding sphere, wherein the raytracing comprises a plurality of vectors that are uniformly distributed in a solid angle, wherein vectors in the plurality of vectors encounter one or more surfaces of the CAD model.

Aspect 17 can include, or can optionally be combined with the subject matter of one or any combination of Aspects 15 or 16 to optionally include when a vector in the plurality of vectors encounters one or more surfaces of the CAD model, the directional sampling registers at least one or more of: a material type of a solid bounded by a subset of the one or more surfaces; a material property of the solid; a first intersection of the vector with a first surface in the one or more surfaces representing an entry location of the vector to the solid; a second intersection of the vector with a second surface in the one or more surfaces representing an exit location of the vector from the solid; a path length of the vector through the solid; or any combination thereof.

Aspect 18 can include, or can optionally be combined with the subject matter of one or any combination of Aspects 15 to 17 to optionally include the radiation transport model generates multiple spherical models, respective spherical models using respective central points in the CAD model for the directional sampling such that a respective TID is determined for multiple electronic components in the CAD model.

Aspect 19 can include, or can optionally be combined with the subject matter of one or any combination of Aspects 15 to 18, to optionally include the spherical model is configured to be used in one or more radiation transport simulations that use a three-dimensional representation of materials as an input, and further that apply effects of physics interactions to simulate passage of particles or radiation through the spherical model; wherein the radiation transport simulation includes radiation sources having a specified energy or range of energies, the radiation sources comprising at least one of: neutrons; photons; electrons; protons; ions; additional elementary particles; or a combination thereof.

Aspect 20 can include subject matter such as a method for generating a radiation transport model, the method comprising: generating a histogram of areal density measurements that are measured by raytracing from a central point of a computer-aided design (CAD) model, the central point corresponding to a position of an electronic component; wherein the raytracing comprises a plurality of vectors that encounter one or more surfaces of the CAD model, wherein the raytracing registers at least one or more of: a material type of a solid bounded by a subset of the one or more surfaces; a material property of the solid; a first intersection of the vector with a first surface in the one or more surfaces representing an entry location of the vector to the solid; a second intersection of the vector with a second surface in the one or more surfaces representing an exit location of the vector from the solid; a path length of the vector through the solid; or any combination thereof; mapping respective bins of the histogram to respective angular extents that are proportional to a number of measurements in the respective bins; generating a spherical model comprising a plurality of longitudinal wedges, each longitudinal wedge having: an areal density value derived from respective bins of the histogram; and an azimuthal angular extent given by the respective bins of the histogram mapped to the respective angular extents; and determining a total ionization dose (TID) using the spherical model as the radiation transport model in a radiation transport simulation that applies effects of particle interactions to simulate passage of particles or radiation through the spherical model; wherein the radiation transport simulation includes radiation sources having a specified energy or range of energies, the radiation sources comprising at least one of neutrons; photons; electrons; protons; ions; additional elementary particles; or a combination thereof, the TID determined for a representative element positioned at a center of the spherical model.

In the event of inconsistent usages between this document and any documents so incorporated by reference, the usage in this document controls.

In this document, the terms “a” or “an” are used, as can be common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel,” “perpendicular,” “round,” or “square,” are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, subject matter may lie in less than all features of a particular disclosed embodiment. Thus, the following claims are hereby incorporated into the Detailed Description as aspects, examples, or embodiments, with each claim standing on its own as a separate embodiment, and it is contemplated that such embodiments can be combined with each other in various combinations or permutations. The scope of the disclosed concepts should be determined with reference to the appended claims, along with the full scope of equivalents to which such claims are entitled.

What is claimed is:

1. A system for generating a radiation transport model, the system comprising:
a memory; and
a processor configured to:
generate a histogram of areal density measurements that are measured by directional sampling of a computer-aided design (CAD) model;
map respective bins of the histogram to respective angular extents that are proportional to a number of measurements in the respective bins;
generate a spherical model comprising a plurality of longitudinal wedges, each longitudinal wedge having:
an areal density value derived from respective bins of the histogram; and
an azimuthal angular extent given by the respective bins of the histogram mapped to the respective angular extents;
determine a total ionization dose (TID) using the spherical model as the radiation transport model, the TID determined for a representative element positioned at a center of the spherical model;
wherein the memory is configured to store the TID.

2. The system of claim 1, the directional sampling further comprising raytracing that originates from a central point in the CAD model and propagates outward to a bounding sphere, the directional sampling uniformly distributed in a solid angle.

3. The system of claim 2, the raytracing comprising a plurality of vectors, wherein respective vectors in the plurality of vectors encounter one or more surfaces of the CAD model.

4. The system of claim 3, wherein when a vector in the plurality of vectors encounters one or more surfaces of the CAD model, the directional sampling registers at least one or more of: a material type of a solid bounded by a subset of the one or more surfaces; a material property of the solid; a first intersection of the vector with a first surface in the one or more surfaces representing an entry location of the vector to the solid; a second intersection of the vector with a second surface in the one or more surfaces representing an exit location of the vector from the solid; a path length of the vector through the solid; or any combination thereof.

5. The system of claim 2, wherein the central point is a location within the CAD model corresponding to a position of an electronic component.

6. The system of claim 5, wherein the processor is configured to generate multiple spherical models, wherein respective spherical models use respective central points in the CAD model for the directional sampling such that a respective TID is determined for multiple electronic components in the CAD model.

7. The system of claim 6, wherein the CAD model comprises a model of a spacecraft, the spacecraft comprising shielding material and electronic componentry.

8. The system of claim 7, wherein the shielding material comprises at least one of: aluminum; copper; plastics; titanium; steel; heavy metal; structural componentry of the spacecraft; or any combination thereof.

9. The system of claim 7, wherein the shielding material is adjusted in the CAD model based on a TID determined for a selected central point, wherein the shielding material adjustment is based on one or more criteria including: enabling a respective electronic component at the selected central point to survive exposure to the TID; and minimizing a total amount of mass in the spacecraft.

10. The system of claim 6, wherein at least one TID is used in selecting an electronic component to be operated at the respective central point, wherein the electronic component is selected such that the electronic component can operate following exposure to the determined TID.

11. The system of claim 1, wherein the representative element is a silicon witness.

12. The system of claim 1, wherein the areal density value for at least one longitudinal wedge in the spherical model comprises at least two material density values, wherein respective material density values have a corresponding thickness in the longitudinal wedge.

13. The system of claim 1, wherein the spherical model is configured to be used in one or more radiation transport simulations that use a three-dimensional representation of materials as an input, and further that apply effects of physics interactions to simulate passage of particles or radiation through the spherical model.

14. The system of claim 13, wherein the radiation transport simulation includes beta particles having an energy distribution in a range of 0.01 mega electron volt (MeV) to 11 MeV, further wherein the radiation transport simulation includes photons having an energy distribution in a range of 0.1 kilo electron volt (keV) to 100 MeV.

15. A non-transitory computer-readable storage device that stores instructions for execution by one or more processors configured to generate a radiation transport model, wherein the processors are configured to:
generate a histogram of areal density measurements that are measured by directional sampling of a computer-aided design (CAD) model;
map respective bins of the histogram to respective angular extents that are proportional to a number of measurements in the respective bins;
generate a spherical model comprising a plurality of longitudinal wedges, each longitudinal wedge having:
an areal density value derived from respective bins of the histogram; and
an azimuthal angular extent given by the respective bins of the histogram mapped to the respective angular extents; and
determine a total ionization dose (TID) using the spherical model as the radiation transport model, the TID determined for a silicon witness positioned at a center of the spherical model.

16. The non-transitory computer-readable storage device of claim 15, wherein directional sampling comprises raytracing that originates from a central point in the CAD model corresponding to a position of an electronic component, wherein the raytracing propagates outward to a bounding sphere, wherein the raytracing comprises a plurality of vectors that are uniformly distributed in a solid angle, wherein vectors in the plurality of vectors encounter one or more surfaces of the CAD model.

17. The non-transitory computer-readable storage device of claim 16, wherein when a vector in the plurality of vectors encounters one or more surfaces of the CAD model, the directional sampling registers at least one or more of: a material type of a solid bounded by a subset of the one or more surfaces; a material property of the solid; a first intersection of the vector with a first surface in the one or more surfaces representing an entry location of the vector to the solid; a second intersection of the vector with a second surface in the one or more surfaces representing an exit location of the vector from the solid; a path length of the vector through the solid; or any combination thereof.

18. The non-transitory computer-readable storage device of claim 17, wherein the radiation transport model generates multiple spherical models, respective spherical models using respective central points in the CAD model for the directional sampling such that a respective TID is determined for multiple electronic components in the CAD model.

19. The non-transitory computer-readable storage device of claim 15, wherein the spherical model is configured to be used in one or more radiation transport simulations that use a three-dimensional representation of materials as an input, and further that apply effects of physics interactions to simulate passage of particles or radiation through the spherical model; wherein the radiation transport simulation includes radiation sources having a specified energy or range of energies, the radiation sources comprising at least one of: neutrons; photons; electrons; protons; ions; additional elementary particles; or a combination thereof.

20. A method for generating a radiation transport model, the method comprising:
generating a histogram of areal density measurements that are measured by raytracing from a central point of a computer-aided design (CAD) model, the central point corresponding to a position of an electronic component; wherein the raytracing comprises a plurality of vectors that encounter one or more surfaces of the CAD model, wherein the raytracing registers at least one or more of: a material type of a solid bounded by a subset of the one or more surfaces; a material property of the solid; a first intersection of the vector with a first surface in the one or more surfaces representing an entry location of the vector to the solid; a second intersection of the vector with a second surface in the one or more surfaces representing an exit location of the vector from the solid; a path length of the vector through the solid; or any combination thereof;
mapping respective bins of the histogram to respective angular extents that are proportional to a number of measurements in the respective bins;
generating a spherical model comprising a plurality of longitudinal wedges, each longitudinal wedge having:
an areal density value derived from respective bins of the histogram; and
an azimuthal angular extent given by the respective bins of the histogram mapped to the respective angular extents; and
determining a total ionization dose (TID) using the spherical model as the radiation transport model in a radiation transport simulation that applies effects of particle interactions to simulate passage of particles or radiation through the spherical model; wherein the radiation transport simulation includes radiation sources having a specified energy or range of energies, the radiation sources comprising at least one of neutrons; photons; electrons; protons; ions; additional elementary particles; or a combination thereof, the TID determined for a representative element positioned at a center of the spherical model.
